(19) United States
(12) Patent Application Publication
(10) Pub. No.: US 2012/0289335 A1
(43) Pub. Date: Nov. 15, 2012

(54) GAMING MACHINE

(76) Inventors: Masanobu Kutomi, Tokyo (JP); Fumihiro Kato, Tokyo (JP); Makoto Kaneko, Tokyo (JP)

(21) Appl. No.: 13/519,460

(22) PCT Filed: Oct. 15, 2010
(86) PCT No.: PCT/JP2010/068132

§ 371 Date: Jun. 27, 2012

(30) Foreign Application Priority Data
Dec. 28, 2009 (JP) 2009-298363

(51) Int. Cl. A63F 13/00

(52) U.S. Cl. 463/33

(57) ABSTRACT

A gaming machine includes: an image display device for displaying a two-dimensional image and a stereoscopic image display unit that covers a part of the display surface and causes a game player to recognize a part of the two-dimensional image at the covered part as a stereoscopic image and to recognize a part of the two-dimensional image at another part as a planar image. The image display unit can compose a first functional film, arranged on a front side of the display surface allowing light from the display surface to pass therethrough and a second functional film arranged on a front side of the first functional film and has a characteristic of reflecting the light from the display surface, which passes through the first functional film, and allowing the light reflected on the first functional film to pass through the second functional film.

### TECHNICAL FIELD

The present invention relates to a gaming machine such as a slot machine, a pachislo gaming machine, and a pachinko gaming machine.

### BACKGROUND ART

In a gaming machine such as a slot machine, a pachislo gaming machine, and a pachinko gaming machine, the following symbol display game is executed. That is, when a predetermined condition is satisfied, one or more symbols are displayed dynamically, and a game result is determined by a lottery or the like. After a lapse of a predetermined time period or in response to an operation of a game player, symbols conforming to the game result are displayed non-dynamically.

The symbol display game as described above is executed mainly by rotating and stopping one or more cylinders (reels) having a plurality of symbols arrayed on their side surfaces, and hence such a game may sometimes be called “reel game”.

In recent years, there have also been employed a gaming machine that omits the reels for cost reduction of the device or the like but instead uses a liquid crystal display device to display the symbol display game in the form of videos, and a gaming machine including a liquid crystal display device for performing a performance representation using videos such as animation, as well as the reels for the symbol display game.

However, in the gaming machine that displays the symbol display game in the form of videos, the image displayed on the liquid crystal display device is a two-dimensional image, and hence it is difficult to reproduce a stereoscopic appearance of real reels. Therefore, game players who are familiar with the symbol display game using the real reels may feel some inconvenience, resulting in diminished enjoyability of the game. Further, in the gaming machine including both the reel device and the liquid crystal display device, there is a problem of cost increase due to the addition of the liquid crystal display device, which leads to another problem in that a powerful performance representation cannot be performed because a small liquid crystal display device needs to be used inevitably due to restriction on an enclosure size.

### CITATION LIST

### Patent Literature

[PTL 1]: JP 2008-154664 A

### SUMMARY OF INVENTION

### Technical Problem

The present invention has been made in view of the above-mentioned problems and achieves one or more of the following objects.

Specifically, the present invention has an object to provide a gaming machine capable of achieving cost reduction of a device and performing composite image display using stereoscopic image display and planar image display.

The present invention has another object to provide a gaming machine capable of achieving cost reduction of a device and displaying stereoscopic reels with high reality.

The present invention has still another object to provide a gaming machine capable of performing, on a single display device, stereoscopic image display of reels with high reality and highly visible image display of videos such as animation, a game screen, and the like with no distortion.

The present invention has yet another object to provide a gaming machine capable of performing a performance representation and enabling a game player to play a game in a novel manner not realized conventionally.

### Solution to Problem

In order to solve the above-mentioned problems, the present invention provides a gaming machine, comprising: an image display device for displaying a two-dimensional image on a display surface thereof; and a stereoscopic image display unit that covers a part of the display surface and causes a game player to recognize a part of the two-dimensional image at the covered part as a stereoscopic image, wherein the game player is caused to recognize a part of the two-dimensional image at other than the covered part as a planar image (claim 1).

In the present invention, a part of the two-dimensional image on the display surface is displayed as a stereoscopic image by the stereoscopic image display unit, and the other part is displayed as a planar image. Accordingly, a display effect equivalent to that in a case of using two display devices, that is, a stereoscopic image display device and a planar image display device, can be attained with use of a single display device. For example, in the part of the stereoscopic image display, an image of reels in a symbol display game can be displayed with high reality, and in the part of the planar image display, game information, animation, and the like can be displayed on a highly visible large screen with no distortion.

In the present invention, it is preferred that the stereoscopic image display unit comprises a first functional film arranged on a front side of the display surface and a second functional film arranged on a front side of the first functional film; the first functional film has a characteristic of allowing light from the display surface to pass therethrough and reflecting light from the second functional film; the second functional film has a characteristic of reflecting the light from the display surface, which passes through the first functional film, and allowing the light reflected on the first functional film to pass through the second functional film; and at least one of the first functional film and the second functional film is curved so that a distance between the first functional film and the second functional film is smaller at a center portion thereof than at upper and lower portions thereof (claim 2).

In the display means of the present invention, the light from the display surface passes through the first functional film, and is then reflected on the second functional film. Further, the light is reflected on the first functional film, and then output forward through the second functional film. That is, the light from the display surface is output through the second functional film after traveling along an optical path that is three times as large as a distance between the first functional film and the second functional film. Therefore, when at least one of the first functional film and the second functional film is curved so that the distance between the first functional film and the second functional film is smaller at the center portion thereof than at the upper and lower portions thereof, human eyes in front of the stereoscopic image display unit recognize the two-dimensional image in the covered part as a stereoscopic image curved into a drum shape.

Thus, through the display of an image showing moving and stopping symbols in the covered part, a symbol display game using a real reel device can be reproduced with high reality.

As the first functional film of the present invention, there may be used an arbitrary film having the characteristic of allowing the light from the display surface to pass therethrough and reflecting the light from the second functional film. As the second functional film of the present invention, there maybe used an arbitrary film having the characteristic of reflecting the light from the display surface, which passes through the first functional film, and allowing the light reflected on the first functional film to pass through the film.

For example, when a liquid crystal display device is used as the image display device of the present invention, as the first functional film, there may be used a polarizing film for converting linearly polarized light from the liquid crystal display device into elliptically polarized light so as to allow the elliptically polarized light to pass through the polarizing film, and converting a rotational direction of elliptically polarized light from the second functional film to an opposite rotational direction so as to reflect the elliptically polarized light. As the second functional film, there may be used a polarizing film for reflecting elliptically polarized light from the first functional film, and allowing elliptically polarized light in the opposite rotational direction to pass through the polarizing film.

In the present invention, it is preferred that the gaming machine further include a first light shielding strip arranged on a front side of the display surface, for blocking light from apart of a predetermined width on at least one of an upper edge and a lower edge of the covered part (claim 3).

When at least one of the first functional film and the second functional film is curved so that the distance between the first functional film and the second functional film is smaller at the center portion thereof than at the upper and lower portions thereof, human eyes in front of the stereoscopic image display unit perceive the two-dimensional image on the display surface to be compressed in the vertical direction through refraction occurring due to the curve of the at least one of the first functional film and the second functional film.

Therefore, there arises a problem in that the images above and below the covered part are displayed on the stereoscopic image display unit so that the images in those parts are displayed in an overlapping manner.

This invention has been provided to solve this problem. The first light shielding strip for blocking the light from the part of the predetermined width on at least one of the upper edge and the lower edge of the covered part is used to avoid such a situation that the images above and below the covered part are displayed on the stereoscopic image display unit. Thus, the problem of the overlapping image display is solved.

The first light shielding strip may be arranged, for example, between the display surface and the first functional film, between the first functional film and the second functional film, or on the front side of the second functional film.

The width dimension of the first light shielding strip may be set equal to a dimension of the compression of the two-dimensional image by the stereoscopic image display unit, or may be set slightly larger than this dimension with a margin.

In the present invention, it is preferred that the gaming machine further include a second light shielding strip for blocking light from a part of the display surface, which is situated on at least one of an upper side and a lower side of the covered part, toward the second functional film (claim 4).

This invention has been provided to solve the problem described in relation to claim 3 by different means.

In this invention, the light from the part of the display surface, which is situated on at least one of the upper side and the lower side of the covered part, toward the second functional film is blocked by the second light shielding strip, and hence it is possible to solve, in a simple manner, the problem in that the images above and below the covered part are displayed on the stereoscopic image display unit.

In the present invention, it is preferred that the gaming machine further include movement means for moving the stereoscopic image display unit in an in-plane direction of the display surface (claim 5).

In this invention, the part of the stereoscopic image display can be moved within the display surface, and hence it is possible to perform the composite image display including the stereoscopic image display and the planar image display in a novel manner not realized conventionally.

For example, in a case of using a stereoscopic image display unit which allows the game player to recognize the two-dimensional image in the covered part as an image on a curved surface that is curved into a drum shape, an image of reels is displayed in the covered part, and a display position of the image of reels is moved in synchronization with the movement of the stereoscopic image display unit. In this manner, it is possible to perform, in accordance with a game status and the like, such image display that the reel device is moving in the gaming machine.

In the present invention, it is preferred that the movement means allow the stereoscopic image display unit to move out of the display surface (claim 6).

In this invention, it is possible to perform the composite image display combining the stereoscopic image display and the planar image display under a state in which the stereoscopic image display unit is situated within the display surface. Further, through the movement of the stereoscopic image display unit out of the display surface, it is possible to display a planar image using the entire display surface, and to display videos such as animation and a video game screen in a highly visible manner with a powerful performance representation.

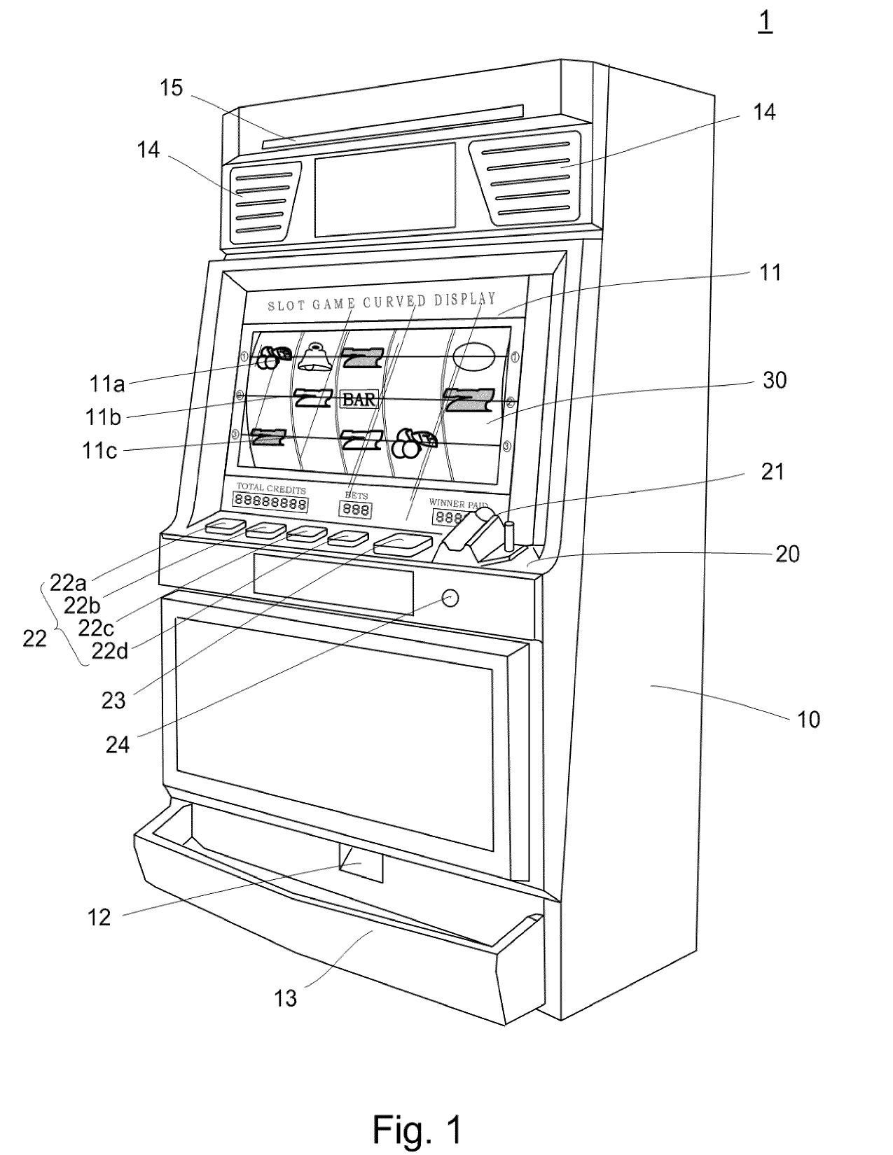

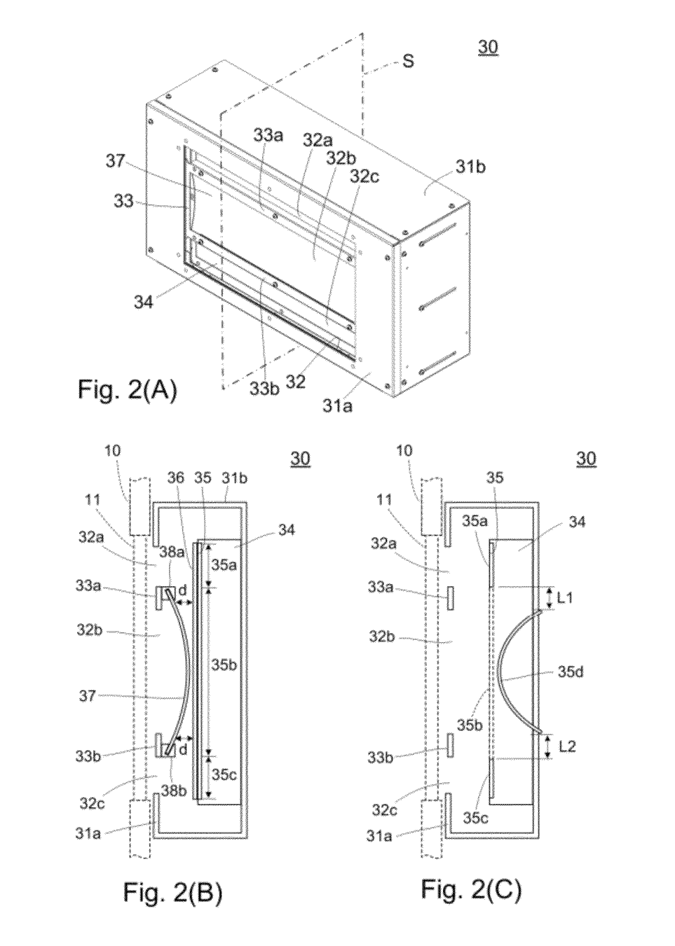

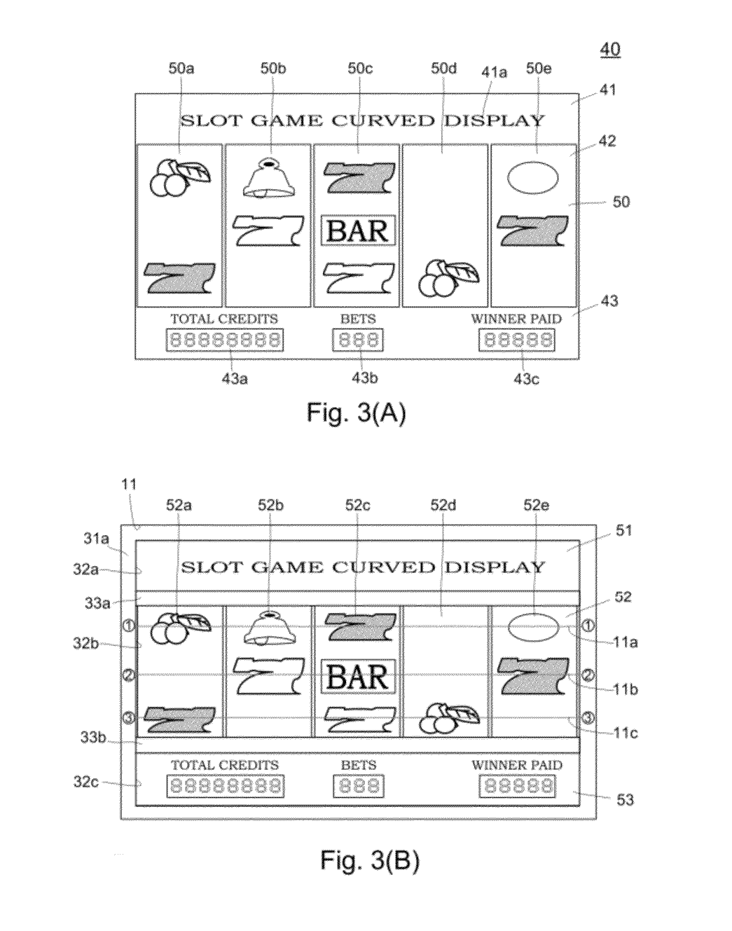

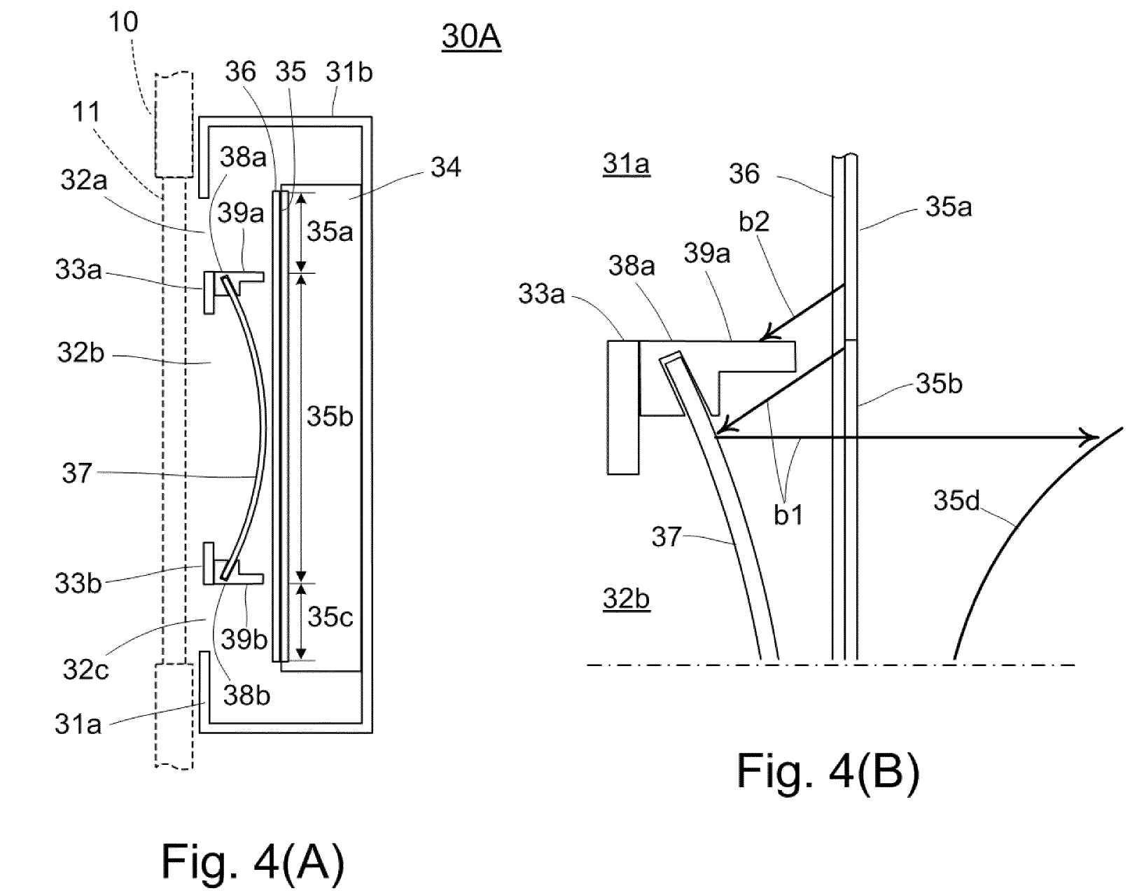

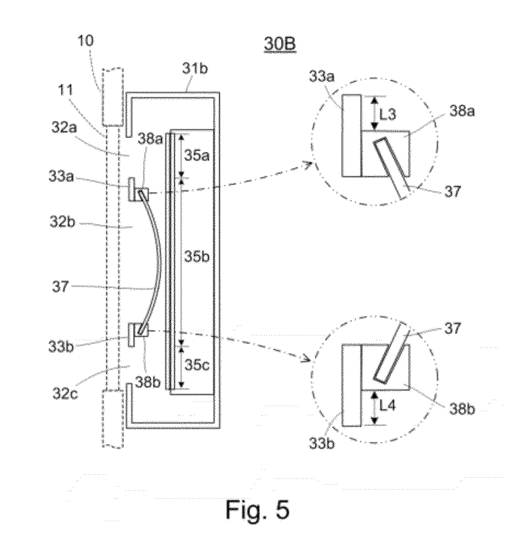

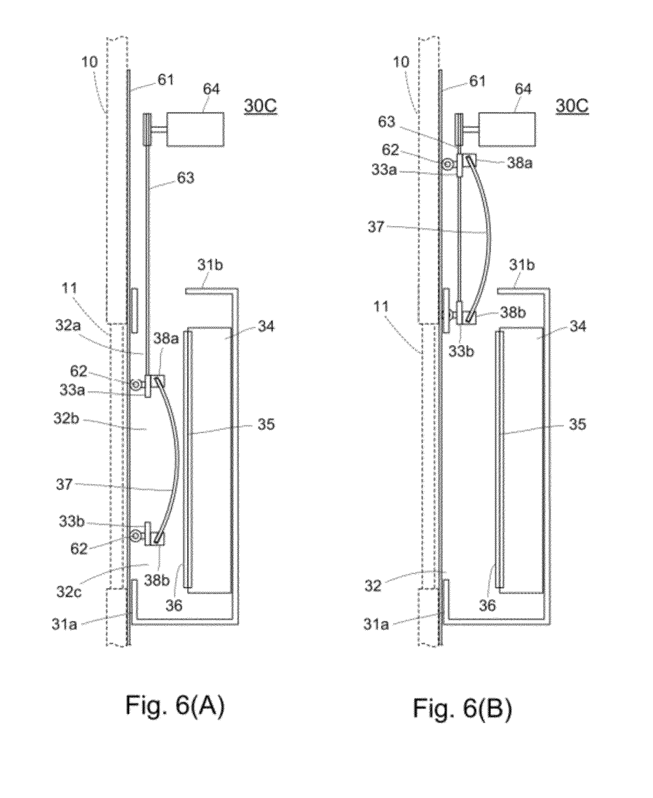

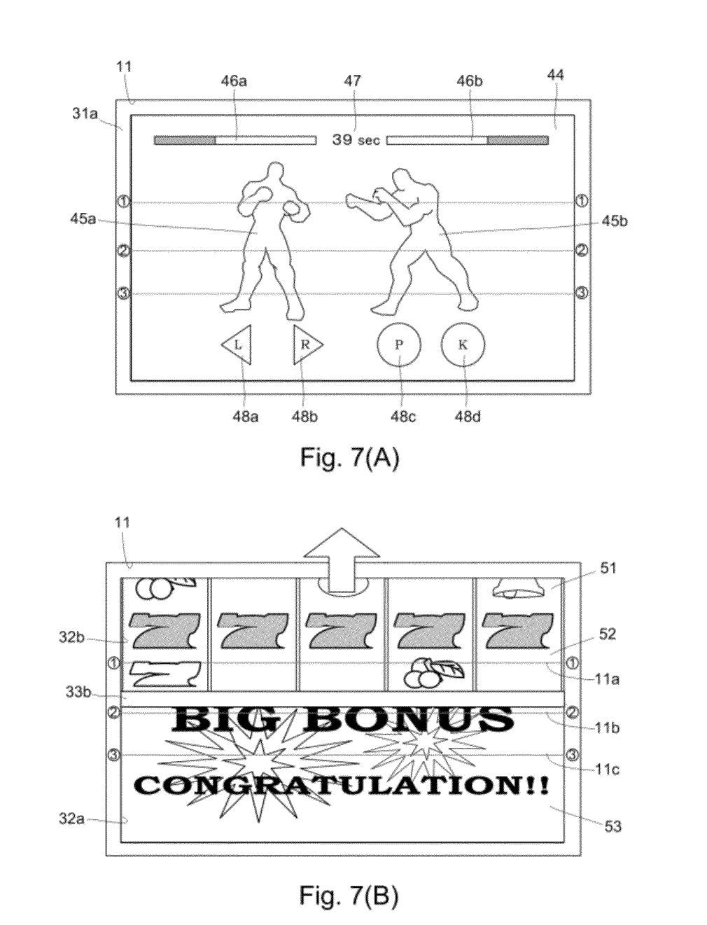

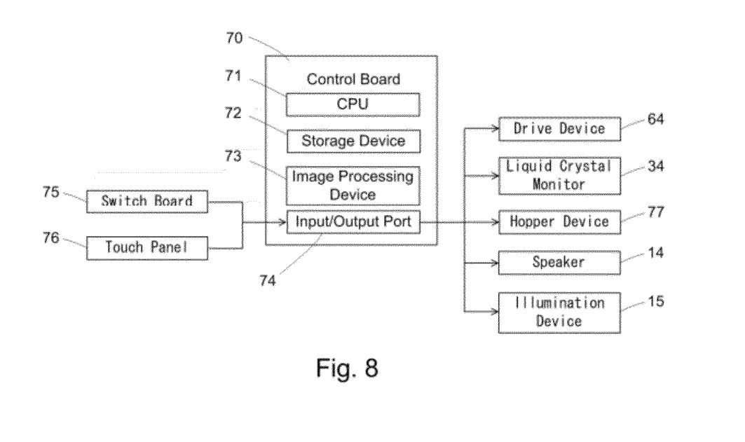

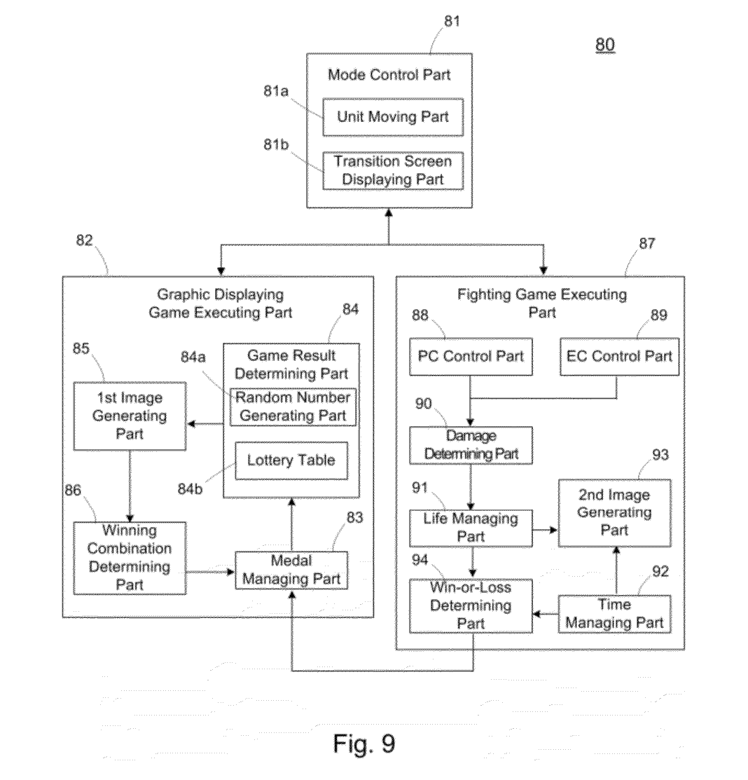

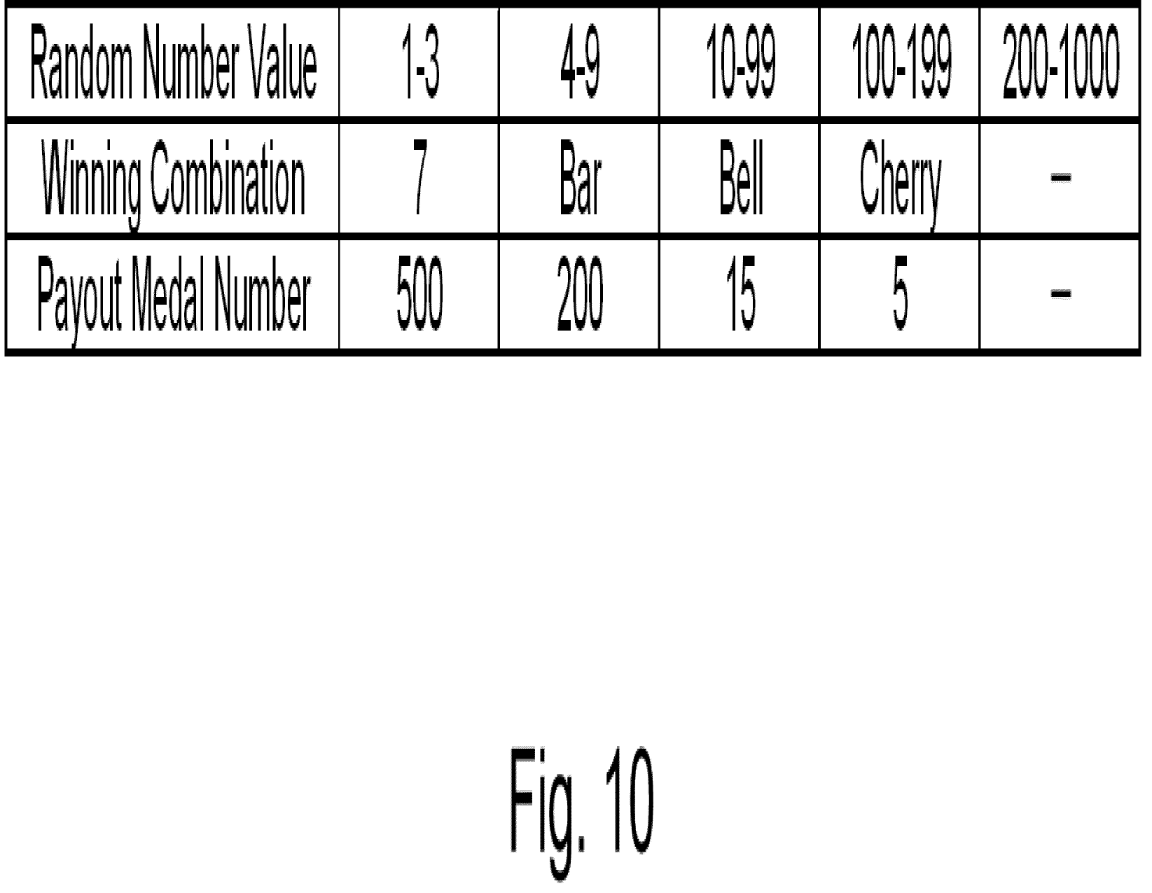

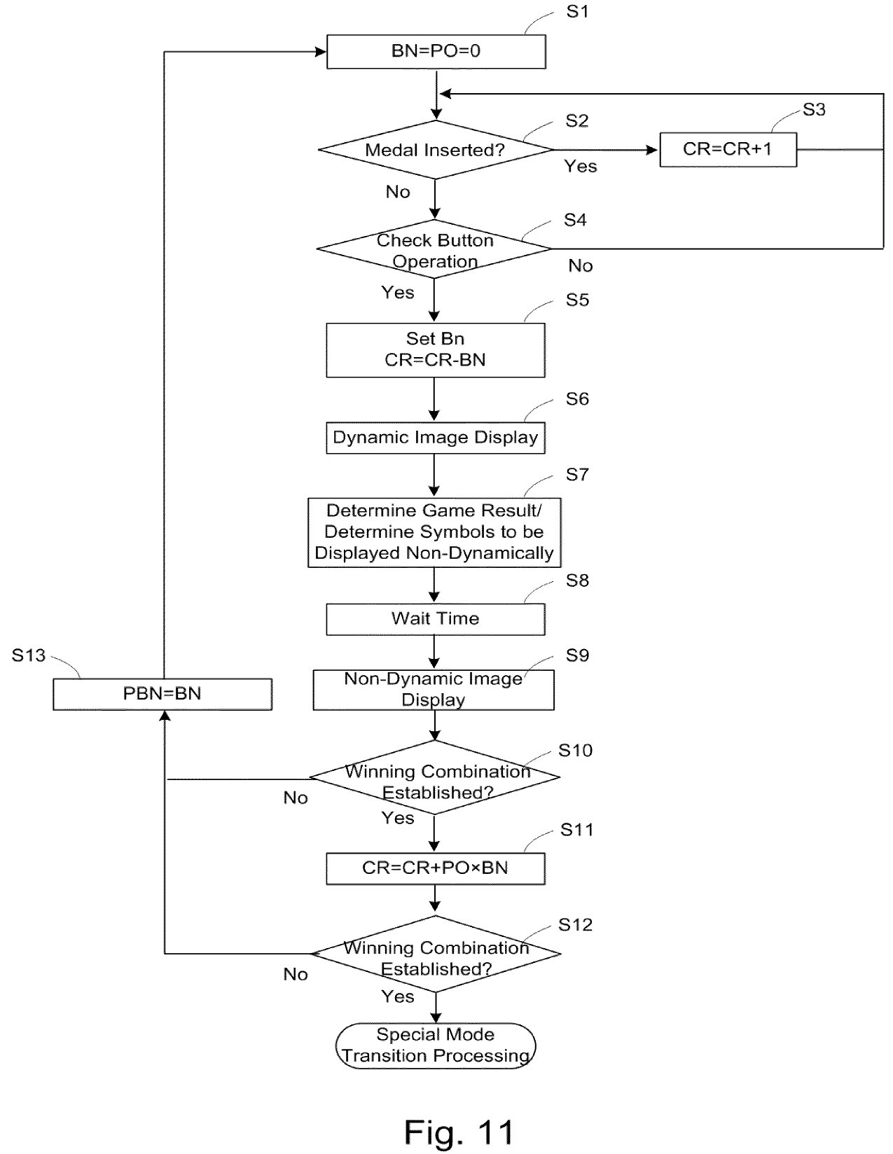

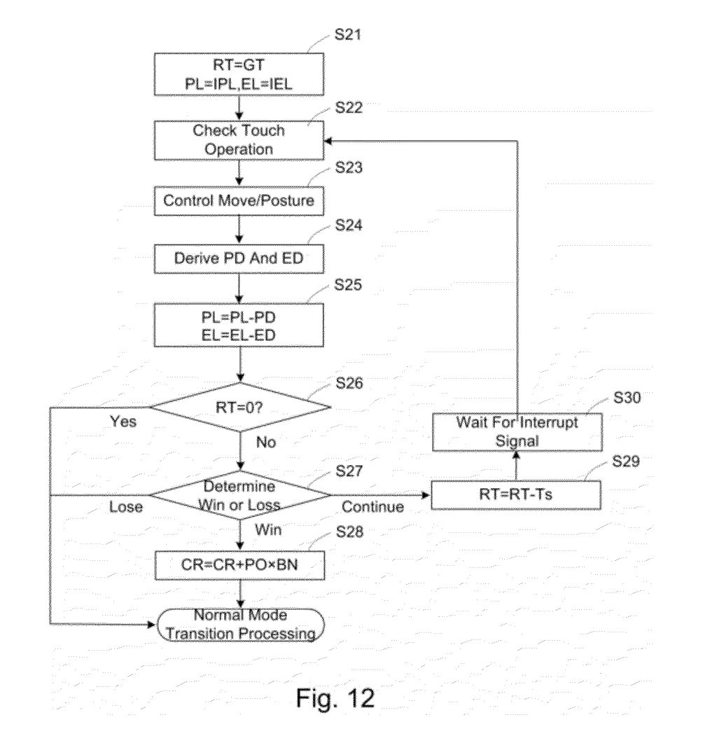

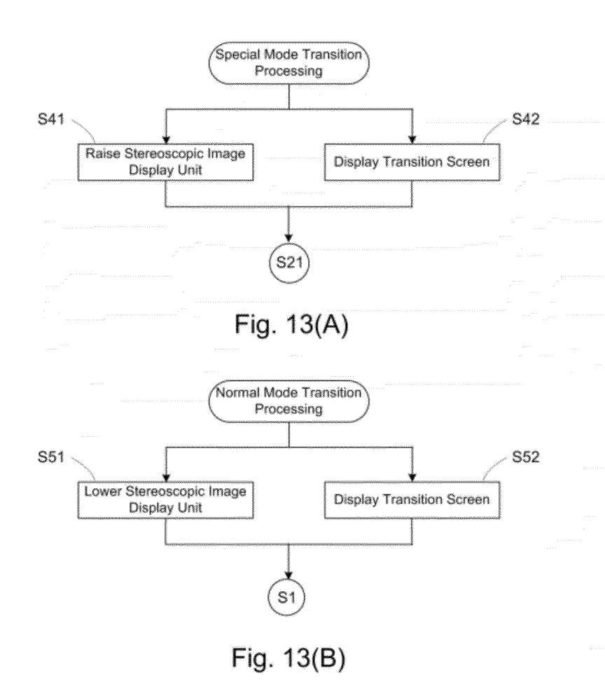

### BRIEF DESCRIPTION OF DRAWINGS

[FIG. 1] An explanatory view illustrating an external appearance of a gaming machine according to an embodiment of the present invention.

[FIG. 2] Explanatory views illustrating a display device according to the embodiment of the present invention.

[FIG. 3] Explanatory views illustrating an exemplary two-dimensional image displayed on a display surface and the two-dimensional image on the display surface as viewed through a display window.

[FIG. 4] Explanatory views illustrating a display device according to another embodiment of the present invention.

[FIG. 5] An explanatory view illustrating a display device according to still another embodiment of the present invention.

[FIG. 6] Explanatory views illustrating a display device according to yet another embodiment of the present invention.

[FIG. 7] Explanatory views illustrating two-dimensional images on the display surface as viewed through the display window.

[FIG. 8] An explanatory diagram illustrating a schematic hardware configuration of the gaming machine according to the embodiment of the present invention.

[FIG. 9] An explanatory diagram illustrating a functional configuration implemented in the gaming machine according to the embodiment of the present invention.

[FIG. 10] An explanatory table showing exemplary winning combination data.

[FIG. 11] An explanatory flow chart illustrating processing to be performed in a symbol display game.

[FIG. 12] An explanatory flow chart illustrating processing to be performed in a fighting game.

[FIG. 13] Explanatory flow charts illustrating special mode transition processing and normal mode transition processing.

### DESCRIPTION OF EMBODIMENTS

Hereinafter, embodiments of the present invention are described by taking as an example a gaming machine 1, which is generally called a slot machine and setup in casinos, video arcades, pachinko parlors, and the like.

FIG. 1 is an explanatory diagram illustrating a configuration of an external appearance of the gaming machine 1 according to the present invention.

In the gaming machine 1, a transparent display window 11 made of glass or the like is provided substantially at a center of an enclosure 10 thereof, and a display device 30 installed behind the display window 11 can be viewed therethrough. Active paylines 11a to 11c for a symbol display game are indicated on a surface of the display window 11. The display window 11 may have a touch panel function depending on the embodiment.

An operation panel 20 for performing a game operation is provided below the display window 11. On the operation panel 20, there are arranged, for example, a game medium insertion port 21 through which a game medium is to be inserted, a plurality of spin buttons 22a to 22d and a re-spin button 23 for instructing execution of the symbol display game, and a cash-out button 24 for cashing out a credited game medium. The spin buttons 22a to 22d are provided so as to execute the symbol display game with different bet numbers, and when the spin buttons 22a to 22d are operated, the symbol display game is executed with a bet of, for example, “one”, “five”, “ten”, and “twenty” game media, respectively. When the re-spin button 23 is operated, the symbol display game is executed with the same bet numbers as those of a previous symbol display game.

As the above-mentioned game medium, an arbitrary medium such as medals, chips, coins, bills, and electronic money may be used. Herein, description is given on the assumption that medals are used as the game medium.

An accumulation box 13 for accumulating medals paid out through a medal payout port 12 is provided on a lower side of the enclosure 10. Further, speakers 14 and an illumination device 15 for outputting sound and light to be used for a performance representation or the like are provided on an upper side of the enclosure 10.

FIG. 2(A) is an explanatory perspective view illustrating the display device 30 installed behind the display window 11, and FIG. 2(B) is a sectional view taken along a virtual plane “S” of the display device 30.

As illustrated, the display device 30 is a box-like member arranged behind the display window 11. The display device 30 includes, on a front side thereof, a front panel 31a provided with an opening 32 that is slightly smaller than the display window 11. On the front panel 31a, there is fixed a light shielding panel 33 having two upper and lower first light shielding strips 33a and 33b each made of an opaque material having a predetermined width dimension.

Thus, the opening 32 is divided into first to third openings 32a to 32c by the first light shielding strips 33a and 33b, and a game player in front of the gaming machine 1 views an image on a liquid crystal monitor 34, which is arranged in the display device 30, through the first to third openings 32a to 32c.

The display device 30 houses the liquid crystal monitor 34 for displaying a two-dimensional image on a flat display surface 35 thereof, a first functional film 36 for covering the entire display surface 35 on a front side thereof, and a second functional film 37 arranged on a front side of the first functional film 36.

The first functional film 36 has a characteristic of allowing light from the display surface 35 to pass therethrough and reflecting light reflected on the second functional film 37. The second functional film 37 has a characteristic of reflecting light passing through the first functional film 36 and allowing light reflected on the first functional film 36 to pass therethrough.

As the first functional film 36 having such a characteristic, there may be used a polarizing film for converting linearly polarized light output from the liquid crystal monitor 34 into elliptically polarized light in a first rotational direction so as to allow the elliptically polarized light to pass through the polarizing film, and converting elliptically polarized light in the first rotational direction from the second functional film 37 into elliptically polarized light in an opposite second rotational direction so as to reflect the elliptically polarized light. As the second functional film 37, there may be used a polarizing film having a characteristic of reflecting elliptically polarized light in the first rotational direction from the first functional film 36, and allowing elliptically polarized light in the second rotational direction from the first functional film 36 to pass through the polarizing film.

The second functional film 37 is held at its upper and lower ends at a predetermined angle by holding members 38a and 38b, which are fixed to rear surfaces of the first light shielding strips 33a and 33b, respectively, and accordingly the second functional film 37 is maintained in a state of being curved into a concave shape at a predetermined curvature. Therefore, a distance “d” between the first functional film 36 and the second functional film 37 is smaller at a center portion of the second functional film 37 than at upper and lower portions thereof.

When assuming that the display surface 35 is divided into three regions, that is, first to third regions 35a to 35c, at an upper end height of the first light shielding strip 33a and at a lower end height of the first light shielding strip 33b, light from the first and third regions 35a and 35c passes through the first functional film 36 and travels linearly and directly toward an outside through the first and third openings 32a and 32c.

On the other hand, light from the second region 35b passes through the first functional film 36 and is then reflected on the second functional film 37 to return to the first functional film 36. The light is again reflected on the first functional film 36 and then passes through the second functional film 37. After that, the light is output to the outside through the second opening 32b.

Thus, an optical path length from the display surface 35 to the opening 32 is different between the light from the first and third regions 35a and 35c and the light from the second region 35b. That is, the optical path length of the light from the first and third regions 35a and 35c is equal to a distance from the display surface 35 to the opening 32, whereas the optical path length of the light from the second region 35b is larger than the optical path length of the light from the first and third regions 35a and 35c by a distance that is twice as large as the distance “d” between the first functional film 36 and the second functional film 37. Further, as for the light from the second region 35b, the distance “d” between the first functional film 36 and the second functional film 37 changes in a height direction, and hence the optical path length changes in the height direction.

FIG. 2(C) is an explanatory view illustrating how the two-dimensional image displayed on the display surface 35 is seen by the game player.

Human eyes perceive light traveling along a longer optical path as light traveling from a distant place. Therefore, the two-dimensional images displayed in the first and third regions 35a and 35c of the display surface 35 are perceived directly as planar images at a position of the display surface 35, whereas the two-dimensional image displayed in the second region 35b is perceived at a position behind the display surface 35 as a stereoscopic image on a curved surface 35d that is curved forward into a convex shape (drum shape). Further, through refraction occurring due to the curve of the second functional film 37, the perceived image in the second region 35b is compressed by predetermined dimensions L1 and L2 at its upper and lower portions, respectively.

In the display device 30 of this embodiment configured as described above, a part of the first functional film 36 covered with the second functional film 37, and the second functional film 37 correspond to a stereoscopic image display unit of the present invention. The stereoscopic image display unit causes the game player in front of the gaming machine 1 to recognize the two-dimensional image in a part covered with the stereoscopic image display unit (two-dimensional image in the second region 35b) as a stereoscopic image.

FIG. 3(A) is an explanatory view illustrating an exemplary two-dimensional image 40 displayed on the display surface 35.

In this example, the two-dimensional image 40 is divided into first to third sections 41 to 43 corresponding to the first to third regions 35a to 35c on the display surface 35 (having the same shape and area and situated at the same position as the first to third regions 35a to 35c), respectively, and images of different contents are displayed in the respective sections 41 to 43.

That is, the first section 41 is set as a display field 41a for decorations and information on a manufacturer name, a gaming machine name, a title logo, and the like. The third section 43 is set as a display field for game information, and displays, for example, a total medal number 43a that is the total number of medals credited in the gaming machine 1, a bet number 43b that is the number of medals bet in each symbol display game, and a payout medal number 43c that is the number of medals paid out in accordance with a game result of each symbol display game. Images on the display fields 41a and 43a to 43c may be any images as long as the images are preferred to be recognized visually as planar images of characters, numerals, decorations, and the like.

In the second section 42, there is displayed a slot image 50 for notifying the game player of the game result of each symbol display game (whether or not a winning combination is established). The slot image 50 is formed of five band images 50a to 50e having various symbols (including blank spaces in addition to such designs as “7”, “BAR”, and pictures of a cherry and a bell) arrayed at predetermined intervals in a vertical direction. When any one of the spin buttons 22a to 22d or the re-spin button 23 is operated, the symbols on the band images 50a to 50e are displayed while being scrolled at high speed from an upper side to a lower side of the band images 50a to 50e, and after a lapse of a predetermined time period, symbols conforming to a game result determined by a lottery or the like in the gaming machine 1 are displayed non-dynamically on the band images 50a to 50e, respectively. Under the state in which the symbols are displayed non-dynamically, as illustrated in FIG. 3(A), three symbols are displayed on each of the band images 50a to 50e.

FIG. 3(B) is an explanatory view illustrating the two-dimensional image 40 displayed on the display surface as viewed through the display window 11.

As described above, due to the difference in optical path length from the display surface 35 to the opening 32, the game player perceives the two-dimensional image 40 as being displayed in the first and third regions 35a and 35c and on the curved surface 35d as illustrated in FIG. 2(C).

As a result, the images in the first and third sections 41 and 43 are perceived as planar images 51 and 53 each arranged at the same position as that of the display surface 35. Thus, the information on characters and numerals, decoration images, animation, and the like can be displayed as the planar images 51 and 53 in a highly visible manner.

On the other hand, the slot image 50 in the second section 42 is perceived as a stereoscopic slot image 52 arranged at a farther position relative to the display surface 35b and situated on the curved surface 35d that is curved forward into a convex shape (drum shape).

In the slot image 52, when the symbols are displayed on the five band images 50a to 50e of the slot image 50 while being scrolled at high speed from the upper side to the lower side of the band images 50a to 50e, five reel images 52a to 52e curved into a convex shape (drum shape) are perceived as being rotated at high speed. Every time the symbols are displayed non-dynamically on the band images 50a to 50e, the corresponding reel images 52a to 52e are perceived as being stopped in rotation. Accordingly, the symbol display game can be enjoyed with a stereoscopic appearance and a powerful performance representation which are similar to those of the symbol display game performed by rotating and stopping the reels having a physically stereoscopic shape.

As described above, in this embodiment, a display effect equivalent to that of the gaming machine including both the reel device and the liquid crystal display device can be attained with use of the liquid crystal monitor 34 that is a single planar image display device.

Further, through refraction occurring due to the curve of the second functional film 37, the two-dimensional image 40 on the display surface 35, which is perceived through the opening 32b, is perceived under a state in which upper and lower portions of the second section 42 are compressed by the predetermined lengths L1 and L2, respectively. Thus, when the light shielding strips 33a and 33b are removed, images on an outer side of the second section 42 (that is, images in the first and third sections 41 and 43) appear in those parts. Therefore, there arises a trouble in that a part of the image in the first section 41 is displayed in an overlapping manner in the planar image 51 and the slot image 52, and a part of the image in the third section 43 is displayed in an overlapping manner in the planar image 53 and the slot image 52.

In this embodiment, the first light shielding strips 33a and 33b for blocking light from the parts of the widths L1 and L2 on the upper edge and the lower edge of the second region 35b of the display surface 35 (parts covered with the stereoscopic image display unit) are arranged on the front side of the display surface 35. Thus, the problem of the above-mentioned overlapping image display is solved.

FIG. 4(A) is an explanatory view illustrating a display device 30A according to another embodiment of the present invention, and FIG. 4(B) is an explanatory enlarged view illustrating a vicinity of an upper end of the second region 35b in the display device 30A.

The display device 30A has the same configuration as the display device 30 except that a second light shielding strip 39a made of an opaque material extends from the holding member 38a toward the upper end of the second region 35b, and that a second light shielding strip 39b made of an opaque material extends from the holding member 38b toward the lower end of the second region 35b.

As illustrated in FIG. 4(B), in the display device 30A, light b1 traveling from the second region 35b toward the second functional film 37 is not blocked by the second light shielding strip 39a, and hence perceived as the image 52 on the curved surface 35 through the second opening 32b, but light b2 traveling from the first region 35a toward the second functional film 37 is blocked by the second light shielding strip 39a so that the light b2 cannot enter the stereoscopic image display unit, and hence the light b2 cannot be perceived through the second opening 32b. The same applies to light traveling from the third region 35c toward the second functional film 37.

Thus, in the display device 30A, it is possible to more reliably prevent the problem in that the images in the first and third regions 35a and 35c are displayed in an overlapping manner in the slot image 52.

FIG. 5 is an explanatory view illustrating a display device 30B according to still another embodiment of the present invention.

The display device 30B has the same configuration as the display device 30 except that the holding member 38a is fixed to the first light shielding strip 33a so that a lower end of the holding member 38a is aligned with a lower end of the first light shielding strip 33a, and that the holding member 38b is fixed to the first light shielding strip 33b so that an upper end of the holding member 38b is aligned with an upper end of the first light shielding strip 33a.

In the display device 30B, the images in the first and third sections 41 and 43 are perceived directly as the planar images 51 and 53, and the image in the second section 42 is perceived, due to the effect of the stereoscopic image display unit, as the stereoscopic slot image 52 on the curved surface 35d that is curved into a convex shape (drum shape). Thus, the same effect as those of the display device 30 are attained.

Further, in the display device 30B, the fixing position of the holding member 38a is shifted downward by a length L3, and the fixing position of the holding member 38b is shifted upward by a length L4 Accordingly, the dimension of the second functional film 37 can be reduced by an amount corresponding to “L3+L4” as compared to the case of the display device 30, and composite image display including the stereoscopic image display and the planar image display can be attained at lower cost.

FIG. 6 are explanatory views illustrating a display device 30C according to yet another embodiment of the present invention.

The display device 30C has the same configuration as the display device 30 except that an opening is provided in a part of an upper panel 31b, and that the display device 30C includes, as additional members, rails 61 extending in the vertical direction at right and left positions of the display device 30C, rollers 62 fixed to the light shielding panel 33 and rollable along the rails 61, and a drive device 64 including a motor and the like, for rolling and unrolling a belt 63 fixed to the light shielding panel 33.

Also in the display device 30C, the part of the first functional film 36 covered with the second functional film 37, and the second functional film 37 function as the stereoscopic image display unit, and the stereoscopic image display unit is integrally driven in the vertical direction by the drive device 64 that rolls and unrolls the belt 63 (the first functional film 36 does not move but the part of the first functional film 36 covered with the second functional film 37 relatively moves along with the movement of the second functional film 37).

In a first state of the display device 30C (FIG. 6(A)), in which the stereoscopic image display unit is situated in the vicinity of a center of the display surface 35, it is possible to perform the composite image display including the planar image display and the stereoscopic image display similar to that of the display device 30. Further, in a second state of the display device 30C (FIG. 6(B)), in which the stereoscopic image display unit is moved to a position at which the lower end of the first light shielding strip 33b is situated above the upper end of the display surface 35 through the drive of the drive device 64, it is possible to powerfully display a planar image on a large screen using the entire display surface 35.

Note that, in the second state, there is no overlapping part of the first functional film 36 and the second functional film 37, and hence the first functional film 36 is not included in the stereoscopic image display unit.

FIG. 7(A) is an explanatory view illustrating a fighting game image 44 as an exemplary two-dimensional image, which is displayed on the entire display surface 35 with the display device 30 set in the second state, as viewed through the display window 11.

In this example, a player character 45a, an opponent character 45b, life gauges 46a and 46b, a remaining time period indicator 47, and operation buttons 48a to 48d are displayed in the fighting game image 44, and the game player can enjoy a fighting game configured such that the player character 45a is operated with use of the operation buttons 48a to 48d to fight against the opponent character 45b.

Further, during a period in which the display device 30C is caused to transition from the first state to the second state, the position of the slot image 50 in the two-dimensional image 40 is scrolled upward in synchronization with upward movement of the stereoscopic image display unit, and accordingly the slot image 52 is lifted as illustrated in FIG. 7(B). In this manner, it is possible to display a transition screen with such a representation that an area of display of the planar image 53 is gradually increased.

Hereinafter, description is given of a hardware configuration, a functional configuration, and an operation mode of the gaming machine 1 including the display device 30C.

FIG. 8 is a block diagram illustrating a schematic configuration of hardware installed in the gaming machine 1.

As illustrated in FIG. 8, the gaming machine 1 has a built-in control board 70 on which a CPU 71, a storage device 72, an image processing device 73, an input/output port 74, and others are mounted.

The CPU 71 is an information processing device that performs overall control of the gaming machine 1 as the center of control operation of the gaming machine 1.

The storage device 72 records programs and data necessary for the gaming machine 1 to operate. The storage device 72 can be constituted of one of, or a combination of, known types of storage such as ROM, RAM, hard disk, and flash memory.

The image processing device 73 is a semiconductor device constituted of, for example, a GPU and a display controller including an image decoder and a frame buffer, and executes processing of generating an image to be displayed on the liquid crystal monitor 34. That is, the GPU executes image generation processing such as geometry processing and rendering processing in accordance with a command from the CPU 71 to render an image of each frame in the frame buffer, and this image is output to the display controller every predetermined time point so that the image is displayed.

Various peripheral devices are connected to the control board 70 via the input/output port 74, and the CPU 71 exchanges signals with those peripheral devices in accordance with a program of the present invention which is recorded in the storage device 72. A gaming operation in the gaming machine 1 is thus executed. Note that, the above-mentioned program of the present invention may originally be recorded in the storage device 72, but may alternatively be installed in the storage device 72 through downloading from a server on a network or copying from a recording medium such as a CD-ROM and a DVD-ROM, which may enhance supportability for change in the game, performance representation, and the like.

The above-mentioned peripheral devices include, for example, a switch board 75 for detecting the operation with respect to each operation member on the operation panel 20 and the insertion of medals, a touch panel 76 attached to the display window 11, for detecting a position of touch by a finger or the like on the display window 11, the drive device 64 for switching between the first state and the second state of the display device 30B, the liquid crystal monitor 34 for displaying the two-dimensional image 40 on the display surface 35, a hopper device 77 for counting medals accumulated in the enclosure 10 and paying out the medals to the accumulation box 41, the speakers 14, and the illumination device 15.

FIG. 9 is an explanatory diagram illustrating a functional block 80 that is implemented in the gaming machine 1 by the CPU 71 executing the program stored in the storage device 72.

As illustrated in FIG. 9, the functional block 80 of this embodiment includes a mode control part 81, a symbol display game executing part 82, and a fighting game executing part 87.

The mode control part 81 is configured to switch a game mode when a predetermined condition is satisfied, and includes a unit moving part 81a for moving the stereoscopic image display unit through the drive of the drive device 64, and a transition screen displaying part 81b for displaying a transition screen during the movement of the stereoscopic image display unit.

In the present invention, arbitrary determination may be performed on, for example, the position of the stereoscopic image display unit to be moved in a specific case, the contents of the game to be performed in accordance with the position of the stereoscopic image display unit, or the image display to be performed on the liquid crystal monitor 34. In a normal mode of the gaming machine 1 according to this embodiment, the display device 30 is set in the first state of FIG. 6(A), and the symbol display game is repeatedly executed by the symbol display game executing part 82. When a specific winning combination such as “7 combination” is established in the symbol display game, the game mode transitions to a special mode, and the fighting game is executed by the fighting game executing part 87 with the display device 30 set in the second state of FIG. 6(B).

The symbol display game executing part 82 is configured to repeatedly execute the symbol display game in the normal mode, and includes a medal managing part 83, a game result determining part 84, a first image generating part 85, and a winning combination determining part 86.

The medal managing part 83 is configured to manage a total medal number CR that is the total number of medals credited in the gaming machine 1, and a bet number BN in each symbol display game. When medals are inserted through the game medium insertion port 21, or when a payout medal number PO is identified by the winning combination determining part 86 or a win-or-loss determining part 94, a credit CR is increased in accordance with the number of inserted medals or the payout medal number PO. When any one of the spin buttons 22a to 22d is operated, a numerical value associated with the operated button among the buttons 22a to 22d is identified as the bet number BN. When the re-spin button 23 is operated, the same bet number BN as that of an immediately preceding symbol display game is identified, and the total medal number CR is decreased by the identified bet number BN.

The game result determining part 84 includes a random number generating part 84a and a lottery table 84b, and is configured to execute processing of determining a game result of the symbol display game every time any one of the spin buttons 22a to 22d or the re-spin button 23 is operated.

In the present invention, types of game result, determination timings, conditions, and methods, and the like are set arbitrarily. The game result determining part 84 of this embodiment is configured to determine whether or not a plurality of types of winning combination predetermined as the game result are established by a lottery at a timing when any one of the spin buttons 22a to 22d or the re-spin button 23 is operated.

Specifically, winning combination data that defines a relationship between the numerical values in a predetermined range (for example, 0 to 999) and the winning combinations is defined in the lottery table 84b. When any one of the spin buttons 22a to 22d or the re-spin button 23 is operated, the random number generating part 84a generates a random number in the above-mentioned range, and this random number is checked against the lottery table 84b so that the game result is determined.

FIG. 10 is an explanatory table showing exemplary winning combination data defined in the lottery table 84b.

In the lottery table 84b of FIG. 10, numerical values in ranges of “1 to 3”, “4 to 9”, “10 to 99”, and “100 to 199” are assigned with “7 combination”, “BAR combination”, “bell combination”, and “cherry combination”, respectively. When the random number generated by the random number generating part 84a matches with one of the numerical values in those ranges, the winning combination assigned to the corresponding range is determined as the game result. When the random number generated by the random number generating part 84a is a numerical value other than the above, a loss is determined as the game result. Note that, for each of the above-mentioned winning combinations, a corresponding symbol (or array or combination of symbols) and a corresponding payout medal number PO are defined. FIG. 10 shows payout medal numbers PO for the respective winning combinations as well.

The first image generating part 85 executes processing of generating image data on the two-dimensional image 40 exemplified in FIG. 3(A).

Specifically, a title logo and the like are displayed in the first section 41, and the total medal number CR and the bet number BN managed by the medal managing part 83, and the payout medal number PO identified by the winning combination determining part 86 are displayed in the display fields 43a to 43c of the third section as appropriate.

Further, the slot image 50 is displayed in the second section 42. When any one of the spin buttons 22a to 22d or the re-spin button 23 is operated, the symbols are displayed on the band images 50a to 50e while being scrolled, and after a lapse of a predetermined time period, symbols conforming to a game result determined by the game result determining part 84 are displayed non-dynamically, respectively.

Based on the symbols displayed non-dynamically by the first image generating part 85, the winning combination determining part 86 determines whether or not the winning combination is established, and when the winning combination is established, the winning combination determining part 86 identifies the payout medal number PO defined for the established winning combination based on the data in the lottery table 84b. For example, when five symbols of “7” are arrayed on any one of the active paylines 11a to 11c, the winning combination determining part 86 determines that the “7 combination” is established, and identifies 500 medals as the payout medal number PO. When five symbols of “BAR” are arrayed, the winning combination determining part 86 determines that the “BAR combination” is established, and identifies 200 medals as the payout medal number PO.

The fighting game executing part 87 is configured to execute a fighting game when the game mode is switched to the special mode, and includes a PC control part 88, an EC control part 89, a damage determining part 90, a life managing part 91, a time managing part 92, a second image generating part 93, and the win-or-loss determining part 94.

The PC control part 88 is configured to derive a position and posture of the player character 45a in a game space at each moment in accordance with a touch operation on the touch panel 76. When right and left buttons 48a and 48b in the fighting game image 44 are touched, the PC control part 88 moves the player character to the right and left in the game space, and when a punch button 48c and a kick button 48d are touched, the PC control part 88 causes the player character 45a to perform punching and kicking actions on the opponent character 45b.

The EC control part 89 is configured to control a position and posture of the opponent character 45b in the game space at each moment in accordance with a predetermined algorithm. Based on the position and posture of the player character 45a, the EC control part 89 causes the opponent character 45b to perform approaching and attacking actions on the player character 45a.

The damage determining part 90 executes processing of deriving a damage value PD of damage to the player character 45a from the attacking action of the opponent character 45b, and a damage value ED of damage to the opponent character 45b from the attacking action of the player character 45a.

The damage values PD and ED may be derived by an arbitrary method. For example, when a hand or leg of one character hits the body or head of the other character, the damage values PD and ED may be derived based on a hit portion, an angle of the hand or leg when hitting the other character, and the like.

The life managing part 91 is configured to manage a life value PL of the player character 45a and a life value EL of the opponent character 45b.

The life values PL and EL may be managed by an arbitrary method. In this embodiment, an initial life value IPL and an initial life value IEL are set for the player character 45a and the opponent character 45b, respectively, and every time the damage determining part 90 derives the damage values PD and ED, the life managing part 91 executes processing of subtracting the damage values PD and ED from the life values PL and EL of the corresponding characters, respectively.

The time managing part 92 is configured to manage a remaining time period RT by subtracting, from a predetermined game time period GT, an elapsed time period since the start of the fighting game.

The second image generating part 93 executes processing of generating the fighting game image 44 exemplified in FIG. 7 (A) based on the information from the PC control part 88, the EC control part 89, the life managing part 91, and the time managing part 92.

Specifically, in accordance with the data on the positions and postures derived by the PC control part 88 and the EC control part 89 every predetermined time point, the second image generating part 93 images a virtual model in which objects for the player character 45a and the opponent character 45b are arranged, and outputs an image overwritten with the life gauges 46a and 46b indicating the life values PL and EL, respectively, and the remaining time period indicator 47 indicating the remaining time period RT. In this manner, the fighting game image 44 is generated.

The win-or-loss determining part 94 determines a win or loss of the fighting game based on the remaining time period RT and the life values PL and EL, and identifies the payout medal number PO based on the determination result and the contents of the game.

In the present invention, arbitrary determination may be performed on, for example, whether or not to determine the win or loss of the fighting game, which method is used therefor, or whether or not to pay out medals based on the determination. In this embodiment, when the life value PL becomes zero by the time the remaining time period RT becomes zero, the win-or-loss determining part 94 determines that the fighting game ends in a loss, and when the life value EL becomes zero, the win-or-loss determining part 94 determines that the fighting game ends in a win. When the remaining time period RT becomes zero under a state in which the life values PL and EL are not zero, the win-or-loss determining part 94 determines that the fighting game ends in a draw.

The payout medal number PO may be set to a predefined number, for example, “500” in a case where the determination results in a win, and “0” in a case where the determination results in a loss. Alternatively, the payout number PO may be calculated with use of a mathematical expression or the like based on the remaining time period RT, the life values PL and EL, and the like.

FIG. 11 is an explanatory flow chart illustrating processing to be executed in the symbol display game by the gaming machine 1 of this embodiment.

As illustrated in FIG. 11, in the symbol display game, in Step S1, the bet number BN and the payout medal number PO are initialized, and then in Step S2, it is checked whether or not a medal is inserted through the game medium insertion port 21. When a medal is inserted (Yes), in Step S3, the total medal number CR is updated, and then the processing returns to Step S2.

When the medal insertion is not detected in Step S2, in Step S4, it is checked whether or not any one of the spin buttons 22a to 22d or the re-spin button 23 is operated. When the operation is not detected (No), the processing returns to Step S2.

When the above-mentioned operation is detected in Step S4 (Yes), the symbol display game is started, and the processing proceeds to Step S5.

In Step S5, the medal managing part 83 sets the bet number BN and updates the total medal number CR based on the button operated in Step S4. Specifically, when any one of the spin buttons 22a to 22d is operated, the bet number BN is set correspondingly to “one”, “five”, “ten”, or “twenty”, and when the re-spin button 23 is operated, a bet number PBN in a previous symbol display game is set as the bet number BN, and the total medal number CR is decremented by the bet number BN thus set.

In Step S6, the first image generating part 85 executes scroll display of symbols on the band images 50a to 50e. Accordingly, the game player can enjoy, with high reality, a state in which the symbols are displayed dynamically through the rotation of the stereoscopic reel images 52a to 52e.

In Step S7, the game result determining part 84 determines the game result, and at the same time, the first image generating part determines symbols to be displayed non-dynamically on the band images 50a to 50e so that the symbols conform to the determined game result.

After that, in Step S8, the processing is brought into a waiting state for a predetermined time period, and then in Step S9, the first image generating part 85 non-dynamically displays the symbols determined in Step S6 sequentially on the band images 50a to 50e. Accordingly, the game player can enjoy, with high reality, a state in which the stereoscopic reel images 52a to 52e are sequentially stopped.

Subsequently, in Step S10, based on the symbols (or array or combination of symbols) displayed non-dynamically in Step S9, the winning combination determining part 86 executes determination of whether or not the winning combination is established.

When any winning combination is established (Yes), the processing proceeds to Step S11, in which the medal managing part 83 executes processing of adding, to the credit CR, a value obtained by multiplying the payout medal number PO defined for the established winning combination by the bet number BN.

Further, in Step S12, it is determined whether or not the established winning combination is a special combination, and when the established winning combination is a special combination (Yes), special mode transition processing is executed so that the game mode transitions to the special mode.

When it is not determined that the winning combination is established (Step S10: No), or when the established winning combination is not a special combination (Step S12: No), the previous bet number PBN is set, and then the processing returns to Step S1 so as to execute a subsequent symbol display game.

FIG. 12 is an explanatory flow chart illustrating processing to be executed in the fighting game by the gaming machine 1 of this embodiment.

As illustrated in FIG. 12, in the fighting game, in Step S21, game parameters are initialized, and in Step S22, it is checked whether or not a touch operation is performed on the touch panel 76.

Subsequently, in Step S23, the PC control part 88 and the EC control part 89 operate to control the positions and/or postures of the player character 45a and the opponent character 45b in the game space in accordance with the operation on the touch panel 76 and a predetermined algorithm.

Then, in Step S24, the damage determining part 90 executes processing of deriving the damage values PD and ED of both characters, respectively. In Step S25, the life managing part 91 executes processing of updating the life values PL and EL based on the damage values PD and ED, respectively. In Step S26, the remaining time period RT managed by the time managing part 92 is checked. When the remaining time period RT becomes zero (Yes), it is determined that the fighting game ends in a draw, and the fighting game is finished.

When the remaining time period RT is not zero (Step S26: No), in Step S27, the win-or-loss determining part 94 executes determination of a win or loss of the fighting game. That is, when the life value PL is zero, the win-or-loss determining part 94 determines that the fighting game ends in a loss, and when the life value EL is zero, the win-or-loss determining part 94 determines that the fighting game ends in a win.

When it is determined in Step S27 that the fighting game ends in a win, in Step S28, a value obtained by multiplying the payout medal number PO identified by the win-or-loss determining part 94 by the bet number BN in an immediately preceding symbol changing game is added to the credit CR, and the fighting game is finished. When it is determined in Step S27 that the fighting game ends in a loss, Step S28 is not executed, and the fighting game is finished.

When the fighting game is finished, normal mode transition processing is executed so that the game mode transitions to the normal mode.

When both the life values PL and EL are not zero in Step S27, it is determined that the game is continued. In Step S29, processing of subtracting a predetermined interrupt time period Ts from the remaining time period RT is executed. In Step S30, the processing is brought into a state of waiting for reception of an interrupt signal to be generated by the CPU, and then the processing proceeds to Step S22.

FIGS. 13(A) and 13(B) are explanatory flow charts illustrating the special mode transition processing and the normal mode transition processing, respectively.

In the special mode transition processing, in Step S41, the unit moving part 81a operates to raise, through the drive of the drive device 64, the stereoscopic image display unit to the position at which the lower end of the first light shielding strip 33b is situated above the upper end of the display surface 35. Accordingly, the display device 30C is caused to transition to the second state illustrated in FIG. 6(B). Simultaneously, in Step S42, the transition screen displaying part 81b operates to display a transition image exemplified in FIG. 7(B) by scrolling upward the position of the slot image 50 in the two-dimensional image 40 in synchronization with the movement of the stereoscopic image display unit.

After completion of the above-mentioned processing, the processing proceeds to Step S21 so as to execute the fighting game.

In the normal mode transition processing, in Step S51, the unit moving part 81a operates to unroll the belt 63 through the drive of the drive device 64, to thereby lower the stereoscopic image display unit to the vicinity of the center of the display surface 35. Accordingly, the display device 30C is caused to transition to the first state illustrated in FIG. 6(A). Simultaneously, in Step S52, the transition screen displaying part 81b operates to execute processing of displaying, on the display surface 35, a transition image for notifying the game player of the transition to the normal mode. Contents of the transition image may be set arbitrarily, and for example, an image showing reverse motion to that in Step S42 maybe employed. As a result, it is possible to produce such a representation that the slot image 52 is lowered from the upper side.

After completion of the above-mentioned processing, the processing proceeds to Step S1 so as to execute the symbol display game.

In the gaming machine 1 of this embodiment, when the display device 30C is set in the first state, the game player can enjoy the symbol display game through the stereoscopic slot image 52 which provides such a high reality that the real reels are used, and at the same time, the information on characters, numerals, and the like, and the animation can be displayed as the planar images 51 and 53 in a highly visible manner. Further, when the display device 30C is set in the second state, a powerful image can be displayed as a highly visible planar image on a large screen using the entire display surface 35. Still further, the image is a flat image, and hence operability can be enhanced in a case where buttons displayed on the image are operated with use of a touch panel system.

The present invention has thus been described through exemplary embodiments. However, the present invention is not limited by the embodiment described above, and various changes and modifications may be made within the scope of claims.

For example, in the embodiments described above, there has been described a case where the entire display surface 35 is covered with the first functional film 36, but alternatively, the first functional film 36 may be arranged only in the second region 35b. In this case, in the display device 30C, the first functional film 36 and the second functional film 37 need to move integrally.

Further, in the embodiments described above, there has been described a case where the second functional film 37 is curved into a concave shape. Similar effects can be attained even when the first functional film is curved into a convex shape, or when both the functional films 36 and 37 are curved.

Further, in the embodiments described above, there has been described a case where the liquid crystal monitor is used as the image display device, but alternatively, a cathode-ray tube display device, a plasma display device, an organic EL display device, or other display device may be used as the image display device. Note that, when the image display device is used in combination with the stereoscopic image display unit using the first and second functional films 36 and 37 of the embodiments described above, a polarizing plate for changing non-polarized light traveling from the display surface 35 to the first functional film 36 into linearly polarized light needs to be arranged additionally between the display surface 35 and the first functional film 36.

Further, in the embodiment using the display device 30C, there has been exemplified a case where the transition is performed between the first state, in which the stereoscopic image display unit is situated in the vicinity of the center of the display surface, and the second state, in which the stereoscopic image display unit is situated out of the display surface. Further, the transition may involve a third state, in which the stereoscopic image display unit is moved to a position on the display surface which is different from the position of the first state (for example, upper end position or lower end position) In this case, the transition between the first state and the third state or between the second state and the third state can be performed in accordance with a game status and game contents.

Further, in the embodiments described above, there has been exemplified a case of using the stereoscopic image display unit which allows the game player to perceive a stereoscopic image curved into a convex shape. Alternatively, a stereoscopic image display unit which allows the game player to perceive a stereoscopic image having a different shape may be used. In this case, it is possible to attain a gaming machine for performing various kinds of game in accordance with the shape of the stereoscopic image.

Besides, the shape, dimension, material, functional configuration, operation mode, control mode of the gaming machine of the above-mentioned embodiments or the members constituting the gaming machine, the kinds of parameter and calculation method to be used for controlling the gaming machine, and the contents of the image and the game are given merely as examples, and modifications may arbitrarily be made thereto within the scope of claims.

### REFERENCE SIGNS LIST

1 . . . gaming machine, 10 . . . enclosure, 11 . . . display window, 11a to 11c . . . active payline, 12 . . . medal payout port, 13 . . . accumulation box, 14 . . . speaker, 15 . . . illumination device, 20 . . . operation panel, 21 . . . game medium insertion port, 22a to 22d . . . spin button, 23 . . . re-spin button, 24 . . . cash-out button, 30, 30A to 30C . . . display device, 31a . . . front panel, 31b . . . upper panel, 32 . . . opening, 33 . . . light shielding panel, 33a, 33b . . . first light shielding strip, 34 . . . liquid crystal monitor, 35 . . . display surface, 36 . . . first functional film, 37 . . . second functional film, 38a, 38b . . . holding member, 39a, 39b . . . second light shielding strip, 40 . . . two-dimensional image, 44 . . . fighting game image, 45a . . . player character, 45b . . . opponent character, 46a, 46b . . . life gauge, 47 . . . remaining time period indicator, 48a to 48d . . . operation button, 50 . . . slot image, 50a to 50e . . . band image, 51, 53 . . . planar image, 52 . . . slot image, 52a to 52e . . . reel image, 61 . . . rail, 62 . . . roller, 63 . . . belt, 64 . . . drive device, 70 . . . control board, 71 . . . CPU, 72 . . . storage device, 73 . . . image processing device, 74 . . . input/output port, 75 . . . switch board, 76 . . . touch panel, 77 . . . hopper device, 80 . . . functional block, 81 . . . mode control part, 81a . . . unit moving part, 81b . . . transition screen displaying part, 82 . . . symbol display game executing part, 83 . . . medal managing part, 84 . . . game result determining part, 85 . . . first image generating part, 86 . . . winning combination determining part, 87 . . . fighting game executing part, 88 . . . PC control part, 89 . . . EC control part, 90 . . . damage determining part, 91 . . . life managing part, 92 . . . time managing part, 93 . . . second image generating part, 94 . . . win-or-loss determining part

1. A gaming machine, comprising:
an image display device for displaying a two-dimensional image on a display surface thereof; and
a stereoscopic image display unit that covers a part of the display surface and causes a game player to recognize a part of the two-dimensional image at the covered part as a stereoscopic image,
wherein the game player is caused to recognize a part of the two-dimensional image at other than the covered part as a planar image.

2. A gaming machine according to claim 1,
wherein the stereoscopic image display unit comprises:
a first functional film arranged on a front side of the display surface; and
a second functional film arranged on a front side of the first functional film,
the first functional film has a characteristic of allowing light from the display surface to pass therethrough and reflecting light from the second functional film,
the second functional film has a characteristic of reflecting the light from the display surface, which passes through the first functional film, and allowing the light reflected on the first functional film to pass through the second functional film, and
at least one of the first functional film and the second functional film is curved so that a distance between the first functional film and the second functional film is smaller at a center portion thereof than at upper and lower portions thereof.

3. A gaming machine according to claim 2, further comprising a first light shielding strip arranged on a front side of the display surface, for blocking light from a part of a predetermined width on at least one of an upper edge and a lower edge of the covered part.

4. A gaming machine according to claim 2, further comprising a second light shielding strip for blocking light from a part of the display surface, which is situated on at least one of an upper side and a lower side of the covered part, toward the second functional film.

5. A gaming machine according to claim 1, further comprising movement means for moving the stereoscopic image display unit in an in-plane direction of the display surface.

6. A gaming machine according to claim 5, wherein the movement means allows the stereoscopic image display unit to move out of the display surface.

7. A gaming machine according to claim 3, further comprising a second light shielding strip for blocking light from a part of the display surface, which is situated on at least one of an upper side and a lower side of the covered part, toward the second functional film.
